(19) United States
(12) Patent Application Publication
(10) Pub. No.: US 2016/0374147 A1
(43) Pub. Date: Dec. 22, 2016

(54) HEATING SEAT WITH HIGH EFFICIENCY FOR VEHICLE

(71) Applicant: LG HAUSYS, LTD., Seoul (KR)

(72) Inventors: Yea-Ri SONG, Seoul (KR); Seong-Hoon YUE, Seongnam-si, Gyeonggi-do (KR); Jong-Hun LEE, Seongnam-si, Gyeonggi-do (KR); Dong-Joo KWON, Daejeon (KR); Chang-Hak SHIN, Seoul (KR); Deok-Ryul HWANG, Seoul (KR); Hwan-Seok PARK, Anyang-si, Gyeonggi-do (KR); Da-Young YU, Anyang-si, Gyeonggi-do (KR)

(21) Appl. No.: 15/122,180

(22) PCT Filed: Mar. 27, 2015
(86) PCT No.: PCT/KR2015/003061

§ 371 Date: Aug. 29, 2016

(30) Foreign Application Priority Data
Mar. 31, 2014 (KR) 10-2014-0038007

(51) Int. Cl. H05B 3/34; H05B 3/10

(52) U.S. Cl. CPC H05B 3/34; H05B 3/10; H05B 2203/01; H05B 2214/04; H05B 2203/004

(57) ABSTRACT

The present invention relates to a heating seat with high efficiency, and the heating seat includes a stack structure of a substrate layer, a first insulation layer, a carbon nanotube heating layer, and a second insulation layer.

### CROSS REFERENCE TO RELATED APPLICATION

This application claims the priority of Korean Patent Application No. 1.0-2014-0038007 filed Mar. 31, 2014 in the Korean Patent and Trademark Office. Further, this application is the National Phase application of International Application No. PCT/KR2015/003061 filed Mar. 27, 2015, which is incorporated herein by reference in its entirety.

### TECHNICAL FIELD

The present invention relates to a highly efficient heating seat for vehicle.

### BACKGROUND ART

In line with acceleration in development of electrical vehicles, interest on a heating system, which was not an issue previously, has increased. A conventional vehicle uses an air-blowing system heating device, but an electrical vehicle does not have a separate heating means, and a battery of the electrical vehicle has disadvantages such as decreases in fuel efficiency and energy efficiency when the outside temperature in winter rapidly drops to about −10° C. or lower.

In order to overcome such disadvantages, a sheet-like heating device using a transfer energy has been applied to a battery to secure evenness of temperature, but power consumption is restricted to warm up an inside temperature of the vehicle during winter season, and thus the effect is not significant. Also, since efficient methods to determine a standard of an atmospheric temperature for a passenger in the vehicle to feel comfortable and that may be commonly used and to achieve the temperature are needed, a heating device that may be applied to an electrical vehicle needs to be developed.

### DISCLOSURE

### Technical Problem

It is an aspect of the present invention to provide a heating seat with high efficiency for a vehicle, and the heating seat may have excellent energy efficiency, even heating performance, and excellent stability while having a light weight.

### Technical Solution

In one embodiment of the present invention, provided is a heating seat with high efficiency for a vehicle, and the heating seat includes a substrate layer; a first insulation layer; a carbon nanotube heating layer; and a second insulation layer.

The substrate layer may include a metal plate formed of a material that comprises at least one selected from the group consisting of aluminum, copper, gold, silver, platinum, and a combination thereof.

The heating seat may not include an adhesive layer.

A thickness of the substrate layer may range from about 15 μm to about 500 μm.

The first insulation layer and the second insulation layer may include an inorganic insulating material.

The inorganic insulating material may include at least one selected from the group consisting of LiF, BaF₂, TiO₂, ZnO, SiO₂, SiC, SnO₂, WO₃, ZrO₂, HfO₂, Ta₂O₅, BaTiO₃, BaZrO₃, Al₂O₃, Y₂O₃, ZrSiO₄, Si₃N₄, TiN, and a combination thereof.

A thickness of each of the first insulation layer and the second insulation layer may range from about 5 μm to about 50 μm.

The carbon nanotube heating layer may be patterned into a predetermined shape by coating a top of the substrate layer with a carbon nanotube paste by silk-screen printing.

The carbon nanotube may be a metal-doped carbon nanotube.

The predetermined shape may include a parallel pattern or a serial pattern.

The parallel pattern may include a first main pattern; a second main pattern; and at least one straight pattern that connects the first main pattern and the second main pattern.

A width of the straight pattern that connects the first main pattern and the second main pattern may range from about 100 μm to about 2 mm.

The serial pattern may include a first main pattern and a second main pattern, wherein at least one of the first main pattern and the second main pattern is formed in a main zigzag pattern; or further comprises a single zigzag pattern that connects the first main pattern and the second main pattern.

A width of the zigzag pattern that connects the first main pattern and the second main pattern may range from about 100 μm to about 2 mm.

A thickness of the carbon nanotube heating layer may range from about 5 μm to about 50 μm.

The heating seat may further include a power unit that is electrically connected to the carbon nanotube heating layer and induces heating of the carbon nanotube heating layer when a voltage is applied.

A heating temperature of the heating layer may range from about 50° C. to about 130° C. when a voltage is applied to the power unit.

### Advantageous Effects

The present invention is capable of preparing a heating seat with high efficiency for a vehicle, and the heating seat may have excellent energy efficiency, even heating performance, and excellent stability while having a light weight.

### DESCRIPTION OF DRAWINGS

FIG. 1 is a schematic view representing a cross-section view of a part including a carbon nanotube heating layer in a heating seat with high efficiency for a vehicle according to an embodiment of the present invention;

FIG. 2a is a schematic view representing a cross-section of a conventional heating seat for a vehicle;

FIG. 2b is a schematic view representing a cross-section of a heating seat with high efficiency for a vehicle according to an embodiment of the present invention;

(a) of FIG. 3 and (a) of FIG. 4 are schematic views each representing an embodiment of a parallel pattern of the carbon nanotube heating layer;

(b) of FIG. 3 and (b) of FIG. 4 are schematic views each representing an embodiment of a serial pattern of the carbon nanotube heating layer;

(c) of FIG. 3 and (c) of FIG. 4 are schematic views each representing another embodiment of a serial pattern of the carbon nanotube heating layer; and

FIG. 5 is a schematic view representing a carbon nanotube heating layer to which a power unit is electrically connected in the heating seat with high efficiency for a vehicle.

### BEST MODE

Hereinafter, an embodiment of the present invention will be described in detail in a manner that the invention may be easily carried out by one of ordinary skill in the art by referring to the attached drawings. The present invention may be carried out in various embodiments, and the invention is not limited to the embodiments described herein.

For clear description of the present invention, parts that are not related to the description are omitted herein, and like reference numerals in the drawings denote like elements throughout the specification.

In the drawings, thicknesses of layers and regions are exaggerated for clarity. Also, thicknesses of some layers and regions are exaggerated in the drawings for convenience of explanation.

Hereinafter, an element formed at an upper part (or a lower part)” of a substrate or “on (or under)” a substrate denotes that an element is formed directly on an upper surface (or a lower surface) of the substrate, and not limited to having no element between the substrate and on (or under) the substrate.

In one embodiment of the present invention, provided is a heating seat with high efficiency for a vehicle, and the heating seat includes a stack structure of a substrate layer, a first insulation layer, a carbon nanotube heating layer, and a second insulation layer.

A heating, ventilation, air condition (HVAC) system included in a common vehicle is a core technology for in-door environment control of a vehicle. However, a PTC heater commonly used for vehicle heating transfers heat by directly heating coolant and thus has disadvantages of consuming a long time to increase a temperature of the coolant and increasing a weight by separately including a pump, a metal plate, and the coolant.

Also, a heating and cooling system of an electric vehicle has used a conventional heating and cooling system used in a conventional vehicle, but due to a problem of about 40% of electrical power of the total energy of an electrical vehicle battery being consumed in heating and cooling, a mileage decreases, and thus the heating and cooling system is constantly needed to be slim and high-efficient. Also, a decrease in heat loss from the heating and cooling system and a structural improvement of a heating seat applied to the heating and cooling system have increased.

In this regard, since the heating seat with high efficiency for a vehicle includes a stack structure of a substrate layer, a first insulation layer, a carbon nanotube heating layer, and a second insulation layer, when the heating seat with high efficiency for a vehicle is used in the heating and cooling system, a consumption power decreases, evenness of temperature during the heating increases, and thus the system may exhibit excellent performance. Also, the electrical vehicle, to which the heating seat is applied, can control in-door environment despite of the outside air in winter.

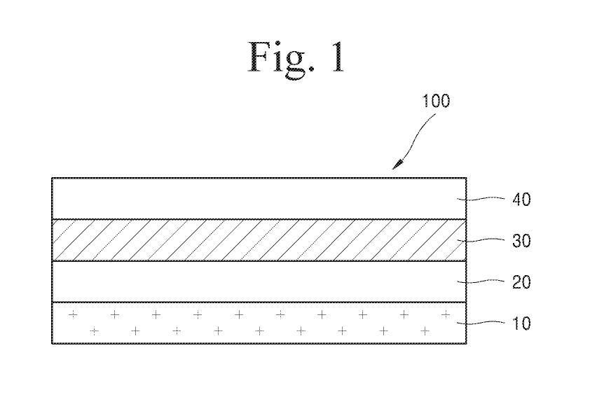

FIG. 1 is a schematic view representing a cross-section view of a part including a carbon nanotube heating layer in a heating seat with high efficiency for a vehicle according to an embodiment of the present invention.

Referring to FIG. 1, the heating seat 100 with high efficiency for a vehicle may include a substrate layer 10, a first insulation layer 20, a carbon nanotube heating layer 30, and a second insulation layer 40 from the bottom. The heating seat with high efficiency for a vehicle has a stack structure of three thin layers on the substrate layer and may be formed based on a material of each of the layers, a printing technique of each of the layers, and a pattern design of the carbon nanotube heating layer 30.

The substrate layer 10 may include a metal plate formed of a material including at least one selected from the group consisting of aluminum, copper, gold, silver, platinum, and a combination thereof. For example, the substrate layer may be an aluminum plate having a high electric conductivity, and the aluminum plate is preferable in terms of no crack generation at external pressure such as thermal contraction or expansion.

A thickness of the substrate layer 10 may range from about 15 μm to about 500 μm. When the thickness of the substrate layer is maintained within this range, the substrate is prevented from being crooked, and heat may spread in a horizontal direction or a vertical direction during the heating.

The first insulation layer 20 and the second insulation layer 40 may include an inorganic insulating material. For example, the inorganic insulating material may include at least one selected from the group consisting of LiF, BaF₂, TiO₂, ZnO, SiO₂, SiC, SnO₂, WO₃, ZrO₂, HfO₂, Ta₂O₅, BaTiO₃, BaZrO₃, Al₂O₃, Y₂O₃, ZrSiO₄, Si₃N₄, and TiN.

An insulating material refers to a material that does not allow heat to pass therethrough, and thus, when the first insulation material and the second insulation material include an insulating material formed of an inorganic material, each of the layers separate the substrate layer and the carbon nanotube heating material, which will be later described in detail, and thus an electric shock may be prevented. In particular, the first insulation layer may prevent electric shock in the substrate layer when the heating is performed by applying a voltage to the heating seat with high efficiency for a vehicle, the second insulation layer may protect a part that releases heat by the voltage application, and the heating seat in a heating module may prevent electric shock and fire.

A thickness of each of the first insulation layer 20 and the second insulation layer 40 may range from about 5 μm to about 50 μm. When the thickness of each of the first insulation layer 20 and the second insulation layer 40 is maintained within this range, cracks and distortion may not occur in the insulation layers during a drying process. Also, thicknesses of the first insulation layer 20 and the second insulation layer 40 may be the same with or different from each other. When the thicknesses of the layers are the same, it may be preferable in terms of efficiency in a printing process, and a heat transfer efficiency may be predicted.

The carbon nanotube heating layer 30 may be patterned in a predetermined shape by coating a top of the substrate layer with carbon nanotube paste by silk-screen printing, and, for example, as shown in FIG. 3 and FIG. 4, the predetermined shape may include a parallel pattern or a serial pattern. The carbon nanotube paste refers to a composition that is prepared by processing carbon nanotubes in the form paste, and, for example, the paste may include an organic solvent, carbon nanotubes, a filler, and an organic binder, and the carbon nanotubes may include at least one selected from single-walled carbon nanofibers or multi-walled carbon nanofibers.

Also, the silk-screen printing is a method that has a screen formed by tightly stretching a cloth of chemical fibers and a printing area formed thereon, and provides ink thereon so that the ink only leaks out through the printing area, which allows the carbon nanotube paste to be coated on the substrate layer in a predetermined pattern or shape. When the carbon nanotube heating layer is formed by the silk-screen printing, the carbon nanotube heating layer may have a parallel pattern or a serial pattern, and a heating site or a heating area may be easily changed by the pattern, and thus efficiency of the heating seat may improve.

The carbon nanotubes may be metal-doped carbon nanotubes. Here, the metal may be silver. The metal-doped carbon nanotubes has a temperature coefficient of resistance that is almost 0, and the resistance value has almost no change after repeated use, reliability may be easily secured. That is, the amendment may not be performed by simply mixing carbon having a negative temperature coefficient of resistance and a metal having a positive temperature coefficient of resistance, but the effect may be produced when metal ions chemically bind to a functional group at an end of an acid-treated carbon nanotube.

For example, the carbon nanotube heating layer 30 may be coated with carbon nanotube paste having a surface resistance of about 10Ω/□ by silk-screen printing, wherein the paste is formed of silver-doped carbon nanotubes, and thus may be patterned in a predetermined shape. When the paste is directly coated on the aluminum plate, adhesive property with the aluminum plate, i.e., the substrate layer, may improve, and thus heat loss of the heating seat with high efficiency for a vehicle may decrease.

A thickness of the carbon nanotube heating layer may range from about 5 μm to about 50 μm. When the thickness of the carbon nanotube heating layer is evenly maintained within this range, crack generation may be prevented, and durability of a certain level may be secured. Also, when the thickness is maintained within this range, a pattern of the carbon nanotube heating layer according to a heat transfer area may be easily changed.

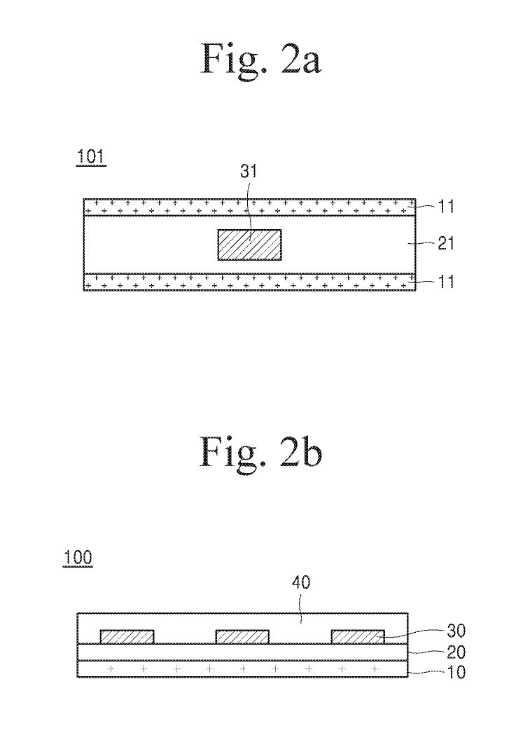

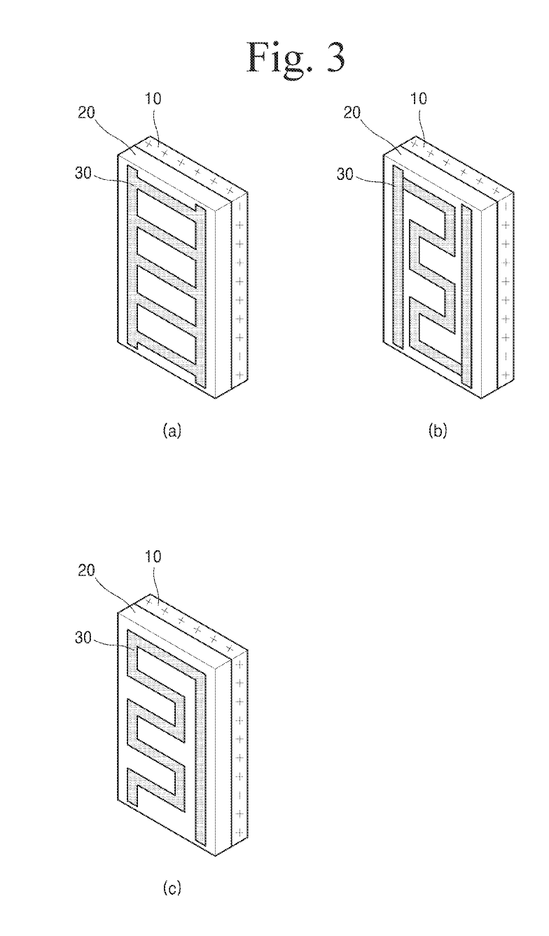

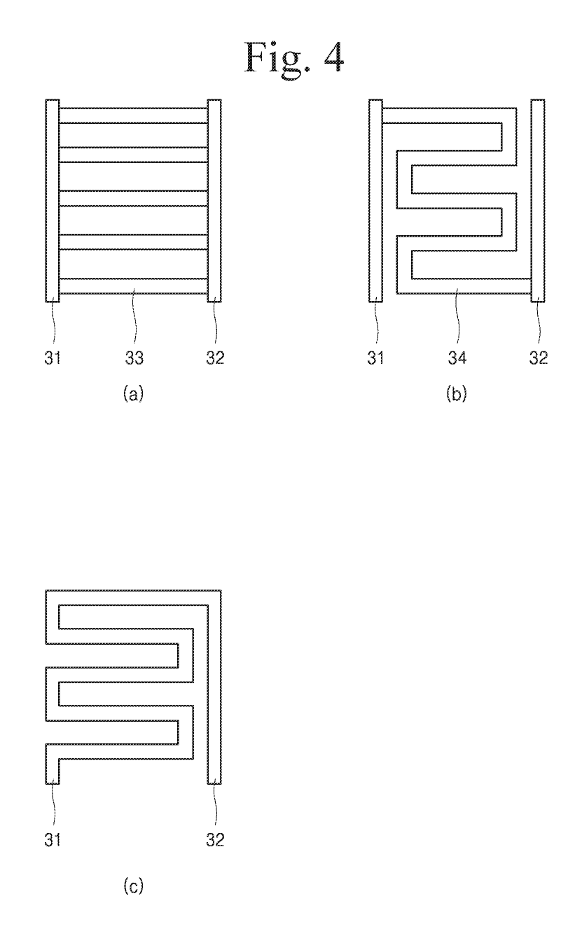

FIG. 2a is a schematic view of a cross-section of a heating seat for a conventional vehicle, and FIG. 2b is a schematic view of a cross-section of a heating seat with high efficiency for a vehicle according to an embodiment of the present invention.

In particular, as shown in FIG. 2a, the heating seat 101 for a conventional vehicle installed in a conventional PTC heater includes a stack structure prepared by sequentially stacking a metal substrate layer 11, an adhesive layer 21 including a ceramic heating layer 31 embedded therein, and a metal substrate layer 11. Accordingly, a current may be supplied to the ceramic heating layer 31 through the adhesive layer 21 by applying a direct voltage to the metal substrate layer 11, and thus the heater may exhibit heating performance.

A thickness of the heating seat 101 of a conventional vehicle increases due to the adhesive layer 21 having a predetermined thickness as the ceramic heating layer 31 is attached to the metal substrate layer with the adhesive layer 21 as a medium, and the heating seat 101 of a conventional vehicle needs to include the metal substrate layer in both surfaces of the adhesive layer 21 to firmly maintain the external appearance for a long time. As a result, the total thickness and weight of the heating seat 101 need to be formed at a high level. Also, heating performance of a ceramic material is low, and thus a thickness or volume of the ceramic heating layer 31 need to be formed at a high level to heat the heating seat 101 up to a desired temperature. In this regard, when the total thickness and weight of the heating seat 101 for a conventional vehicle are high, driving performance and fuel efficiency of a vehicle may further deteriorate.

Further, since the current flows in the metal substrate layer itself, a rush current may easily occur during the use process, excessive heating may occur at a topical site, and thus a risk of fire is high.

However, the heating seat 100 with high efficiency for a vehicle according to an embodiment of the present invention includes a stack structure prepared by sequentially stacking a substrate layer, a first insulation layer, a carbon nanotube heating layer, and a second insulation layer. Then, as described in relation to a power unit which will be described later, a rivet may be used so that the carbon nanotube heating layer directly contacts a wire, and a voltage is directly applied to supply a current, which allows heat performance to be exhibited.

In this regard, the heating seat 100 with high efficiency for a vehicle has a heating layer formed of a carbon nanotube material, which relatively increases the heating performance, and thus a thickness of the carbon nanotube heating layer may be formed thin, or the layer may be patterned so that the heating performance may be exhibited thoroughly even.

At the same time, since only an insulation layer may be included without including the adhesive layer 21, only one substrate layer may be included, which may decrease a thickness and a weight of the heating seat, and thus generation of a rush current may be effectively prevented.

As a result, since the total thickness and weight of the heating seat with high efficiency for a vehicle according to an embodiment of the present invention decrease, the heating seat may be prepared having a light weight, and thus driving performance and fuel efficiency of the vehicle improve, which may result in excellent energy efficiency. At the same time, there is an advantage of having even heating performance and excellent stability.

For example, in terms of efficiency, a weight of an HVAC module, to which the heating seat 100 with high efficiency for a vehicle is applied, is about 57 g, more or less, which is about 31% less than that of a conventional PTC heater, and, in terms of heating the whole area of the substrate layer, a consumption power may be about 20% saved compared to that of the conventional PTC heater.

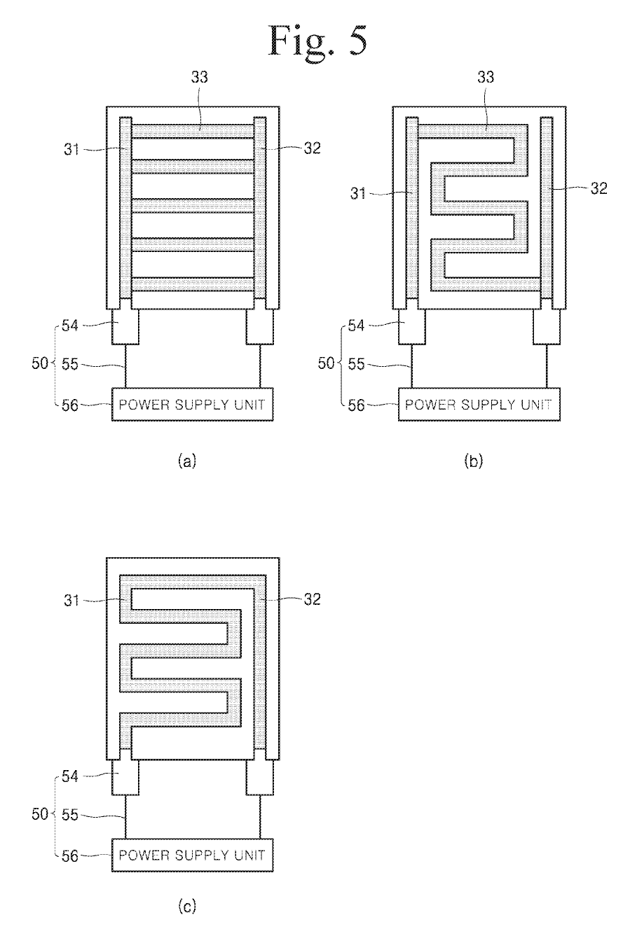

The heating seat 100 with high efficiency for a vehicle may further include a power unit that is electrically connected to the carbon nanotube heating layer 30 and induces heating of the carbon nanotube heating layer when a voltage is applied thereto. FIG. 5 shows a schematic view of a carbon nanotube heating layer to which a power unit 50 is electrically connected in the heating seat 100 with high efficiency for a vehicle.

The schematic view represents the power unit 50 electrically connected to the carbon nanotube heating layer in the heating seat 100 with high efficiency for a vehicle.

The power unit 50 may include a rivet 54, a wire 55, and a power supply unit 56.

The rivet 54 is a pressure fixing member, for example, including a wire connection terminal, and fixes the wire 55 to be fixed in contact with the carbon nanotube heating layer 30 to connect the carbon nanotube heating layer 30 and the wire 55.

The rivet 54, the wire 55, and the power supply unit 56 may be general ones used in the art and are not particularly limited thereto.

A voltage, for example, about 3 V to about 24 V, may be applied to the power unit 50, and, here, since a rush current does not occur, an electrical characteristic of securing stability when the power unit 50 is ON/OFF may be possible. Also, due to a high efficiency heating seat installed in the HVAC module, temperatures of a surface and periphery of the heating seat may evenly increase, and a heating area may also increase.

A heating temperature of the heating layer when a voltage is applied to the power unit 50 may range from about 50° C. to about 130° C. In terms of heating performance, the heating seat 100 with high efficiency for a vehicle has a heating temperature, which is about 15° C. to about 30° C. higher than that of the conventional PTC heater and thus may reach a desired target temperature by consuming a small electrical power. The heating temperature refers to a surface temperature of the carbon nanotube heating layer when a voltage is applied to the power unit 50, and when a voltage is applied to the power unit 50, heat is generated to the carbon nanotube heating layer, and due to the heat thus generated, the carbon nanotube heating layer may maintain a constant heating temperature.

In particular, when the heating temperature of the heating layer is lower than about 50° C., the heating effect of the heating seat may not influence the whole heating and cooling system, and when the heating temperature of the heating layer is higher than about 130° C., excessive heating may occur, the heating and cooling system may not operate, and lifespan of the heating seat may decrease.

FIG. 3(a) and FIG. 4(a) are schematic views each representing an embodiment of a parallel pattern of the carbon nanotube heating layer, FIG. 3(b) and FIG. 4(b) are schematic views each representing an embodiment of a serial pattern of the carbon nanotube heating layer, and FIG. 3(c) and FIG. 4(c) are schematic views each representing another embodiment of a serial pattern of the carbon nanotube heating layer. In this regard, the carbon nanotube heating layer 30 may include a parallel pattern or a serial pattern.

The parallel pattern may include a first main pattern 31; a second main pattern 32; and at least one straight pattern 33 that connects the first main pattern 31 and the second main pattern 32. In this regard, the parallel pattern may be a pattern that is connected with the first main pattern 31, the second main pattern 32, and the at least one straight pattern 33.

When the power unit 50 is further included, the first main pattern 31 and the second main pattern 32 may be patterns that are electrically, directly connected to the power unit 50, or, in particular, may be a pattern to which the wire 55 is directly in contact by a wire connection terminal of the rivet 54 included in the power unit 50. For example, as shown in FIG. 5, the wire 55 may be fixed and connected to contact an end part of the first main pattern 31 and the second main pattern 32 by the rivet 43.

Also, a width of each of the first main pattern 31 and the second main pattern 32 may range from about 100 μm to about 2 mm.

For example, in the parallel pattern, the first main pattern 31 and the second main pattern 32 may be a pair of main straight patterns that are parallel to each other with a predetermined distance therebetween, and the predetermined distance may range from about 0.5 mm to about 50 mm, but it is not limited thereto or may be appropriately changed according to a size of the heating seat 100 with high efficiency for a vehicle.

As shown in FIG. 3(a) and FIG. 4(a), the at least one straight pattern 33 that connects the first main pattern 31 and the second main pattern 32 may intersect the first main pattern and the second main pattern to connect those, and when a plurality of the straight patterns 33 are included, the plurality of straight patterns 33 may parallel to one another.

In particular, a width of each of the straight patterns that connect the first main pattern 31 and the second main pattern 32 may range about 100 μm to about 2 mm. An area of the carbon nanotube heating layer may be easily secured by maintaining a width range of the straight patterns in the parallel pattern, and the area of the heating layer may be easily changed according to a shape of the pattern.

The serial pattern includes the first main pattern 31 and the second main pattern 32, wherein one of the first main pattern 31 and the second main pattern 32 is formed in a main zigzag pattern; or may further include one zigzag pattern 34 that connects the first main pattern 31 and the second main pattern 32.

When the power unit 50 is further included, the first main pattern 31 and the second main pattern 32 may be a pattern to which the power unit 50 is electrically, directly connected, or, for example, may be a pattern to which the wire 55 is directly in contact by a wire connection terminal of the rivet 54 included in the power unit 50. For example, as shown in FIG. 5, the wire 55 may be fixed and connected to contact an end part of the first main pattern 31 and the second main pattern 32.

Also, a width of each of the first main pattern 31 and the second main pattern 32 may range from about 100 μm to about 2 mm.

For example, in the parallel pattern, as shown in FIG. 3(b) and FIG. 4(b), when one of the first main pattern 31 and the second main pattern 32 is formed in a main zigzag pattern, the other one may be formed into a main straight pattern that is connected to the main zigzag pattern.

Also, for example, in the serial pattern, as shown in FIG. 3(c) and FIG. 4(c), the first main pattern 31 and the second main pattern 32 may be a pair of main straight patterns that parallel each other with a predetermined distance therebetween, and the predetermined distance may range, for example, from about 0.5 mm to about 50 mm, but it is not limited thereto.

In this regard, when the first main pattern 31 and the second main pattern 32 are a pair of main straight patterns, one zigzag pattern 34 that connects the first main pattern 31 and the second main pattern 32 may be additionally included in the serial pattern. That is, the one zigzag pattern 34 having a predetermined area may connect the first main pattern and the second main pattern.

A width of the zigzag pattern that connects the first main pattern 31 and the second main pattern 32 may range from about 100 μm to about 2 mm. When the zigzag pattern maintains the width range, a contact area of the first main pattern and the second main pattern may be secured, and thus a current according to a voltage applied to the power unit 50 may flow. Also, a heating area of the heating layer may be easily formed by the serial pattern by preventing topical heating.

When the heating layer includes the parallel pattern, a surface resistance of the heating layer may range from about 0.5Ω/□ to about 10Ω/□, and when the heating layer includes the serial pattern, a surface resistance of the heating layer may range from about 0.5Ω/□ to about 10Ω/□. Therefore, when the heating layer includes the parallel pattern, it is preferable in terms of a current that flows fluently by having a lower surface resistance. Also, the parallel pattern may require a low process cost and preparation time compared to those of the serial pattern.

However, in terms of preventing topical heating, the serial pattern is preferable in terms of evenness of heating compared to that of the parallel pattern, and thus stability and temperature evenness of the heating seat may both improve by mixing the parallel pattern and the serial pattern and simultaneously integrating advantages of the straight pattern and the zigzag pattern.

Hereinafter, detailed examples of the present invention are provided. However, the examples provided herein are only for the purpose of practice or describe the present invention in detail, and thus the present invention is not limited thereto.

### EXAMPLE AND COMPARATIVE EXAMPLE

### Example

A first insulation layer having a thickness of 20 μm including an inorganic insulating material formed of SiO₂ and ZnO was stacked on a top of an aluminum plate having a thickness of 500 μm, carbon nanotube paste including 30 parts by weight of carbon nanotubes, 5 parts by weight of a filler, and 20 parts by weight of an organic binder based on 100 parts by weight of an organic solvent was applied and coated thereon by silk-screen printing to form a carbon nanotube heating layer having a thickness of 10 μm. Then, a second insulation layer having a thickness of 20 μm including an inorganic insulating material formed of SiO₂ and ZnO was formed on the carbon nanotube heating layer, thereby preparing a heating seat with high efficiency for a vehicle.

Here, a heater for an electric vehicle including the heating seat with high efficiency for a vehicle applied to a heat core for an electric vehicle was used.

### Comparative Example

A PTC heater (PTC Polo, HVAC system) was applied to a heat core for an electrical vehicle. In particular, the PTC heater (PTC Polo, HVAC system) included a heating seat formed in a stack structure prepared by sequentially stacking an aluminum plate having a thickness of 500 μm, an adhesive layer having a ceramic heating layer embedded therein and having a thickness of 1.8 mm, and an aluminum plate having a thickness of 500 μm.

### Experimental Example

### Heating Characteristics of Heating Seat with High Efficiency for Vehicle

1) Heater performance evaluation: a voltage was applied to a power unit of the heaters prepared in Example and Comparative Example at electrical powers shown in Table 1, respectively. Then, a heating temperature of each of the heating seats was measured, and the results are shown in Table 1.

TABLE 1

| | | 3 V | 6 V | 8 V |
|---|---|---|---|---|
| Example | Heating power(W) | 209 | 210 | 212 |
| | Air mass flow(kg/min) | 1.34 | 2.94 | 3.95 |
| | Temp difference(° C.) | 14 | 10 | 9 |
| | Max. heat core temp. | 115 | 78 | 72 |
| | (° C.) | | | |
| Comparative | Heating power(W) | 206 | 211 | 207 |
| Example | Air mass flow(kg/min) | 1.36 | 2.97 | 4.16 |
| | Temp difference(° C.) | 11 | 5 | 5 |
| | Max. heat core temp. | 75 | 47 | 43 |
| | (° C.) | | | |

Referring to Table 1, the heating temperature of the heating seat of Example was measured about 30° C. or higher than a heating temperature of the heating seat of Comparative Example, and thus it was confirmed that when the same electrical power and the same voltage were applied, performance of the heating seat of Example was better than performance of the heating seat of Comparative Example.

2) Module performance evaluation: the heaters of Example and Comparative Example were installed in a common HVAC module, and voltages (8V, 6V) were applied to the power unit at the same electrical power (210 W), an in-door temperature in an electrical vehicle and the maximum surface temperature of the heater were measured by using a thermometer, and the results are shown in Table 2.

TABLE 2

| | | 8 V | 6 V |
|---|---|---|---|
| | | (4 kg/min) | (3 kg/min) |
| Example | Air Temperature | 9 | 10 |
| | Increase (K) | | |
| | Maximum Surface | 72 | 78 |
| | Temp.(° C.) | | |
| Comparative | Air Temperature | 5 | 5 |
| Example | Increase (K) | | |
| | Maximum Surface | 43 | 47 |
| | Temp.(° C.) | | |

Referring to Table 2, the case of using the heater of Example had the in-door temperature in an electrical vehicle and the maximum surface temperature of the heater higher than those of the case of using the heater of Comparative Example, and thus when the same electrical power and the same voltage were applied, the heater of Example had high performance compared to the heater of Comparative Example in regard of the consumption power. That is, it was clearly confirmed that heating performance of the heating seat of Example was better under the same voltage.

3) Weight evaluation: a weight of each of the heating seats prepared in Example and Comparative Example were measured by using a scale (GF-4000, available from AND Co., Japan), and the results are shown in Table 3.

TABLE 3

| | Weight (g) |
|---|---|
| Example | 58 |
| Comparative Example | 89 |

Referring to Table 3, a weight of the heating seat of Example further decreased, which effectively made the weight light, and thus it may be clearly expected that further improved energy efficiency may be possible by improving driving performance and fuel efficiency of a vehicle.

<Reference numerals>

| 100: heating seat with high efficiency for cars | |
|---|---|
| 10: substrate layer | |
| 20: first insulation layer | |
| 21: adhesive layer | |
| 30: carbon nanotube heating layer | |
| 31: ceramic heating layer | |
| 31: first main pattern, | 32: second main pattern, |
| 33: straight pattern, | 34: zigzag pattern |
| 40: second insulation layer | |
| 50: power unit | |
| 54: rivet | |
| 55: wire | |
| 56: power supply unit | |

1. A heating seat with high efficiency for a vehicle, the heating seat comprising:
a substrate layer;
a first insulation layer;
a carbon nanotube heating layer; and
a second insulation layer

2. The heating seat of claim 1, wherein the substrate layer comprises a metal plate formed of a material that comprises at least one selected from the group consisting of aluminum, copper, gold, silver, platinum, and a combination thereof.

3. The heating seat of claim 1 not comprising an adhesive layer.

4. The heating seat of claim 1, wherein a thickness of the substrate layer ranges from about 15 μm to about 500 μm.

5. The heating seat of claim 1, wherein the first insulation layer and the second insulation layer comprise an inorganic insulating material.

6. The heating seat of claim 5, wherein the inorganic insulating material comprises at least one selected from the group consisting of LiF, BaF₂, TiO₂, ZnO, SiO₂, SiC, SnO₂, WO₃, ZrO₂, HfO₂, Ta₂O₅, BaTiO₃, BaZrO₃, Al₂O₃, Y₂O₃, ZrSiO₄, Si₃N₄, TiN, and a combination thereof.

7. The heating seat of claim 1, wherein a thickness of each of the first insulation layer and the second insulation layer ranges from about 5 μm to about 50 μm.

8. The heating seat of claim 1, wherein the carbon nanotube heating layer is patterned into a predetermined shape by coating a top of the substrate layer with a carbon nanotube paste by silk-screen printing.

9. The heating seat of claim 8, wherein the carbon nanotube is a metal-doped carbon nanotube.

10. The heating seat of claim 8, wherein the predetermined shape comprises a parallel pattern or a serial pattern.

11. The heating seat of claim 10, wherein the parallel pattern comprises
a first main pattern;
a second main pattern; and
at least one straight pattern that connects the first main pattern and the second main pattern.

12. The heating seat of claim 11, wherein a width of the straight pattern that connects the first main pattern and the second main pattern ranges from about 100 μm to about 2 mm.

13. The heating seat of claim 10, wherein the serial pattern comprises a first main pattern and a second main pattern, wherein at least one of the first main pattern and the second main pattern is formed in a main zigzag pattern; or further comprises a single zigzag pattern that connects the first main pattern and the second main pattern.

14. The heating seat of claim 13, wherein a width of the zigzag pattern that connects the first main pattern and the second main pattern ranges from about 100 μm to about 2 mm.

15. The heating seat of claim 1, wherein a thickness of the carbon nanotube heating layer ranges from about 5 μm to about 50 μm.

16. The heating seat of claim 1 further comprising a power unit that is electrically connected to the carbon nanotube heating layer and induces heating of the carbon nanotube heating layer when a voltage is applied.

17. The heating seat of claim 16, wherein a heating temperature of the heating layer ranges from about 50° C. to about 130° C. when a voltage is applied to the power unit.
